(19) United States
(12) Patent Application Publication
(10) Pub. No.: US 2024/0308273 A1
(43) Pub. Date: Sep. 19, 2024

(54) DURABLE TIRES AND RELATED METHODS

(71) Applicant: The Goodyear Tire & Rubber Company, Akron, OH (US)

(72) Inventors: Gilles Reichling, Vichten (LU); Bernd Zotz, Hanau (DE); Philippe Joseph Auguste Muller, Champlon (BE); Nicolas Claude Jean-Claude Froger, Haucourt-Moulaine (FR); Richard Mbewo Samwayera Fosam, Moesdorf (LU); Wojciech Franciszek Baran, Ettelbruck (LU); Patrick Wietor, Palzem (DE)

(21) Appl. No.: 18/426,476

(22) Filed: Jan. 30, 2024

Related U.S. Application Data
(60) Provisional application No. 63/490,373, filed on Mar. 15, 2023.

(51) Int. Cl. B60C 9/18; B60C 9/20; B60C 13/00

(52) U.S. Cl. CPC B60C 9/1835; B60C 9/20; B60C 13/00; B60C 2009/1864; B60C 2009/2064; B60C 2009/2067; B60C 2013/006; B60C 2013/007

(57) ABSTRACT

A tire may include: a tread cap; a carcass that comprises a radially outermost ply; a belt structure interposed between the carcass and the tread, the belt structure comprising a radially innermost belt; a pair of sidewall portions, wherein radially outermost portions of each sidewall overlie lateral end portions of the tread cap; a pair of bead regions, wherein the radially innermost belt wraps around the bead regions; a pair wraparound gum layers, wherein each wraparound gum layer wraps around a lateral end portion of the radially innermost belt; and a pair of sidewall gum layers that each extend along an outer surface of the radially outermost ply, wherein a first end of each sidewall gum layer is between the radially outermost ply and the lateral end portion of the radially innermost belt and a second end of each sidewall gum layer is at the bead region.

### FIELD OF THE INVENTION

The present disclosure relates generally to pneumatic tires and, more particularly, pneumatic tires with improved durability.

### BACKGROUND OF THE INVENTION

A pneumatic tire typically includes a pair of axially separated inextensible beads having at least one carcass ply extending between the two beads. The carcass ply includes axially opposite end portions each of which can be turned up around a respective bead and secured thereto. Tread rubber and sidewall rubber are located axially from and radially outward of, respectively, the carcass ply.

During operation, the rubber of the tire sidewall deforms, which creates heat and accelerates wear of the sidewall. To restrict deformations, the thickness of rubber of the tire side portion can be increased. However, the associated increased weight can increase the rolling resistance of the tire, which reduces tire performance and fuel economy as well as increases wear in other locations of the tire. Therefore, solutions to reduce the heat generation or accumulation at the sidewall with minimal increase in overall tire weight is desired.

### SUMMARY OF THE INVENTION

The disclosure provides in a first aspect a pneumatic tire comprising first and second annular bead cores axially spaced from one another and a carcass including at least one ply wrapped around the first and second bead cores, each ply of the at least one ply defining a pair of turned up ends extending from the bead cores to outer end points of each ply. First and second bead regions are wrapped by the at least one ply such that the first and second bead regions are bounded laterally by the at least one ply and the turned up ends, and bounded radially by radially innermost edges of respective annular bead cores and radially outermost end points of respective turned up ends. A belt structure is disposed radially outward of the carcass, the belt structure including a radially innermost belt having first and second lateral end portions terminating in respective first and second lateral edges of the radially innermost belt respectively. First and second sidewall gum layers extend along a surface of the at least one ply from a first end to a second end, the first end disposed axially inward of a respective lateral edge of the radially innermost belt and radially between the at least one ply and a respective lateral end portion of the radially innermost belt, the second end disposed within a respective bead region of the first and second bead regions.

In another aspect, the disclosure is directed to a pneumatic tire comprising a tread cap, a carcass, a belt structure, a pair of sidewall portions, a pair of bead regions and a pair of sidewall gum layers. The carcass comprises at least one ply wrapped around first and second axially spaced bead cores, each ply of the at least one ply defining a pair of turned up ends extending from the bead cores to outer end points of each ply. The belt structure is interposed between the carcass and the tread cap. The belt structure comprises a radially innermost belt terminating at opposed first and second lateral edges. Radially outermost portions of each sidewall portion overlie lateral end portions of the tread cap. The pair of bead regions each include an annular bead core of the first and second bead cores, wherein the carcass wraps around the pair of bead regions such that the regions are bounded laterally by the at least one ply and the turned up ends, and bounded radially by radially innermost edges of the respective annular bead cores and radially outermost end points of respective turned up ends. A first sidewall gum layer extends along a surface of the at least one ply from a first end axially inward of the first lateral edge of the radially innermost belt to a second end within a first bead region of the pair of bead regions, and a second sidewall gum layer extends along the surface of the at least one ply from a first end axially inward of the second lateral edge of the first belt to a second end within a second bead region of the pair of bead regions.

According to another aspect, the disclosure is directed to a pneumatic tire comprising a carcass that comprises at least one ply wrapped around first and second axially spaced bead cores. Each ply of the at least one ply defines a pair of turned up ends extending from the bead cores to outer end points of each ply. A belt structure is disposed radially outward of the carcass. The belt structure comprises a radially innermost belt having two lateral end portions. The tier further includes a pair of bead regions, wherein the at least one ply wraps around the pair of bead regions such that the regions are bounded laterally by the at least one ply and the turned up ends, and bounded radially by radially innermost edges of the respective annular bead cores and radially outermost end points of respective turned up ends. The tire further includes a pair of sidewall portions, wherein each of the sidewall portions is disposed axially outward of one of the pair of bead regions. The tire further includes a pair of sidewall gum layers, wherein a first sidewall gum layer is disposed axially between a first sidewall portion of the pair of sidewall portions and extends along a surface of the at least one ply from a first end between the at least one ply and the first lateral end portion of the radially innermost belt to a second end within a first bead region of the pair of bead regions, and wherein a second sidewall gum layer is disposed axially between a second sidewall portion of the pair of sidewall portions and extends along the surface of the at least one ply from a first end between the at least one ply and the second lateral end portion of the radially innermost belt to a second end within a second bead region of the pair of bead regions.

### Definitions

The following definitions are applicable to the present invention.

“Apex” means an elastomeric filler located radially above the bead core and between the plies and turned up ends of the plies.

“Axial” and “axially” mean lines or directions that are parallel to the axis of rotation of the tire.

“Bead core” means an annular tensile member reinforcing the bead region of a tire, commonly constructed of steel wire, cords or cables.

“Bead Region” means that part of the tire wrapped by a carcass and including a bead core. The bead region may be shaped, with or without other reinforcement elements such as flippers, chippers, apexes, toe guards, and chafers, to fit the design rim.

“Belt structure” means at least two annular layers or plies of parallel cords, woven or unwoven, underlying the tread, unanchored to the bead, and having cords inclined with respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Elastomer” means a resilient material capable of recovering size and shape after deformation.

“Equatorial plane (EP)” or “Equatorial Centerplane (CP) means the plane perpendicular to the axis of rotation of the tire and passing through the center of the tire tread.

“Groove” means an elongated void area in a tread that may extend in a circumferential, lateral or angled manner about the tread in a straight, curved, or zigzag configuration. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves have substantially reduced depth as compared to wide circumferential grooves which interconnect, they are regarded as forming “stiffener elements” tending to maintain a rib-like character in the tread region involved.

“Inner” means toward the inside of the tire.

“Innerliner” means the layer or layers of elastomer or other material that form the inside surface of a tubeless tire and that contain the inflating fluid within the tire.

“Lateral” and “laterally” are used to indicate axial directions across the tread of the tire.

“Lateral edges” means a line tangent to the axially outermost tread contact patch or footprint as measured under normal load and tire inflation, the lines being parallel to the equatorial centerplane.

“Outer” means toward the outside of the tire.

“Ply” means a cord-reinforced layer of rubber; rubber-coated, radially deployed or otherwise parallel cords.

“Pneumatic Tire” means a laminated mechanical device of generally toroidal shape (usually an open-torus) having beads and a tread and made of rubber, chemicals, fabric, and steel or other materials. When mounted on the wheel of a motor vehicle, the tire through its tread provides traction and contains the fluid that sustains the vehicle load.

“Radial” and “radially” are used to mean directions radially toward or away from the axis of rotation of the tire.

“Sidewall” means that portion of a tire between the tread and the bead.

“Sidewall-over-tread” refers to a tire design and method of fabrication in which the radially outermost portions of each sidewall of a tire overlie the lateral end portions of the tread.

“Tread” means a molded rubber component which includes that portion of the tire that comes into contact with the road when the tire is normally inflated and under normal load. The tread has a depth conventionally measured from the tread outer surface to the bottom of the deepest groove of the tire.

### BRIEF DESCRIPTION OF THE DRAWINGS

The invention will be described by way of example and with reference to the accompanying drawings in which:

FIG. 1 illustrates a cross-sectional view of one half of a nonlimiting example tire of the present disclosure.

FIG. 2 is an enlarged view of the area of interest identified in FIG. 1 illustrating a first end of a sidewall gum layer in contact with a wedge that supports a lateral end portion of a belt.

FIG. 3 is a view similar to FIG. 2 illustrating the first end of the sidewall gum layer in contact with a wraparound gum layer disposed around the lateral end portion of the belt.

FIG. 4 is a view similar to FIG. 2 illustrating the first end of a sidewall gum layer in direct contact with the lateral end portion of the belt.

FIG. 5 is an enlarged view of the area of interest identified in FIG. 1 illustrating a sidewall gum layer extending to a bead filler apex within a bead region of the tire.

FIG. 6 is a view similar to FIG. 5 illustrating the sidewall gum layer extending to an opposite lateral side of the bead filler apex within a bead region.

FIG. 7 is a view similar to FIG. 5 illustrating the sidewall gum layer extending to a bead core within a bead region that does not include a bead filler apex therein.

FIG. 8 is a view similar to FIG. 5 illustrating the sidewall gum layer extending to point radially outward of bead filler apex within a bead region.

### DESCRIPTION

The present disclosure relates generally to tires and, more particularly, tires with improved durability. The tires of the present disclosure may be used in multiple applications, such as: race tires, passenger vehicle tires, and heavy load tires.

The tires of the present disclosure include thin layers (e.g., 0.2 mm to 2 mm thick) of extra rubber (referred to herein as gum layers) that are strategically placed to absorb and dissipate energy and heat generated when the sidewall flexes, for example, during rolling. Advantageously, the gum layers are thin and only in a portion of the tire construction, and, therefore, contribute minimal weight to the overall tire while still improving durability.

FIG. 1 illustrates a cross-sectional view of a pneumatic tire 10 according to at least some embodiments of the present disclosure. The tire 10 has a sidewall-over-tread (SOT) design. However, the teachings of the present disclosure (especially the placement, compositions, and dimensions of the wraparound gum layers and sidewall gum layers) may be applied to other tire designs include tread-over-sidewall designs.

The tire 10 includes a tread cap 12, a belt structure 14 comprising belts 24,26, a pair of sidewall portions 16,18, a pair of bead regions 20a,20b, a carcass structure 22, a pair of wedges 40a,40b, and an innerliner 21.

While the illustrated belt structure 14 includes two belts 24,26, any number of belts (e.g., 1 to 10) may be included in a tire 10 of the present disclosure. In the illustrated tire 10, the first belt 24 is radially inward of the second belt 26. In tires 10 of the present disclosure, the first belt 24 (the radially innermost belt) of the belt structure 14 is preferably the widest belt of the belt structure 14. Preferably, the first belt 24 has a belt width substantially equal to the tread arc width. The breaker angle of first belt 24 is between about 12 degrees and 45 degrees, preferably with a left orientation, more preferably in the range of about 19 degrees to about 30 degrees. The belt angles are measured with respect to the circumferential direction.

The second belt 26 is located radially outward of the first belt 24. The second belt 26 preferably has a width in the range of 30% to 50% of the tread arc width. The second belt 26 has a breaker angle between about 12 degrees and 45 degrees, preferably with a right orientation, more preferably in the range of about 19 degrees to about 30 degrees. The second belt 26 is preferably made of the same wire as the first belt 24 and has the same construction with the same but opposite angular orientation as first belt 24.

The first and second belts 24,26 are preferably made of steel. The % elongation at 10% of breaking load of the first and second belts 24,26 may range from about 0.18 to about 0.26. Preferably, the first and second belts 24,26 are extensible, so that the % elongation at 10% of breaking load is greater than 0.2. The % elongation is measured on a cord extracted from a vulcanized tire.

Generally, for SOT and other designs, the sidewalls 16,18 extend substantially outward from each of the bead regions 20a,20b in the radial direction of the tire 10. The illustrated tire 10 is a sidewall-over-tire (SOT) design where the radially outermost portions 16a, 18a of each sidewall 16,18 of a tire 10 overlie the lateral end portions 12a, 12b of the tread cap 12, respectively.

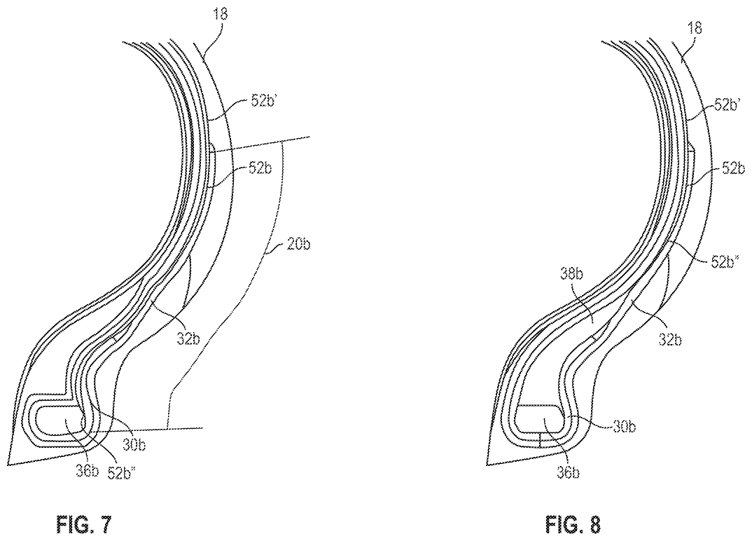

The pair of bead regions 20a,20b include a pair of annular bead cores 36a,36b. In some embodiments, as illustrated in FIG. 1, the bead regions 20a,20b each further include a respective bead filler apex 38a,38b. In other embodiments (see FIG. 7), the bead regions 20a,20b may include bead cores 36a,36b without including bead filler apexes 38a,38b.

The carcass 22 is radially outward of the innerliner 21. The carcass 22 comprises a first ply 30 and second ply 32 radially inward of the first ply 30. While the illustrated carcass 22 includes two plies 30,32, any number of plies (e.g., 1 to 10) may be included in a tire 10 of the present disclosure. During the manufacturing sequence, the plies can be installed such that the portions of some or all of the plies extend into the bead region 20a,20b are turned up around the respective bead cores 36a,36b to create turned up ends. In the illustrated example, the first and second plies 30,32 both include turned up ends 30a,32a and 30b,32b around each of the respective bead cores 36a,36b. The turned up ends 30a,32a extend from the bead cores 36a,36b to outer end points 30a′,32a′30b′,32b′ of each ply 30,32. The carcass 22 wraps around the bead regions 20a,20b such that at least one of the plies 30,32 extend along both inner and outer axial sides of the bead region 20a, 20b. For example, the turned up ends 32a, 32b of the second ply 32 extend along outer axial sides of the bead regions 20a,20b and the first ply 30 extends along inner axial sides of the bead regions 20a,20b.

Each wedge 40a,40b is located, at least partially, at between a respective lateral end portion 24a,24b of the first belt 24 (the radially innermost belt) and the first ply 30 (the radially outermost ply). That is, a first wedge 40a is, at least partially, between a first lateral end portion 24a of the first belt 24 (the radially innermost belt) and the first ply 30 (the radially outermost ply), and a second wedge 40b is, at least partially, between a second lateral end portion 24b of the first belt 24 and the first ply 30. Wedges 40a,40b may support the lateral end portions 24a,24b and assist in maintaining a predetermined curvature of the first belt 24. The wedges 40a,40b may be constructed of a rubber or elastomer, or any of the materials described below for the construction of the “gum layers” described herein. As illustrated, each wedge 40a,40b extends axially outward past a respective lateral edge 24a′, 24b′ of the first belt 24 to be between the respective lateral end portion 12a, 12b of the tread cap 12 and the first ply 30.

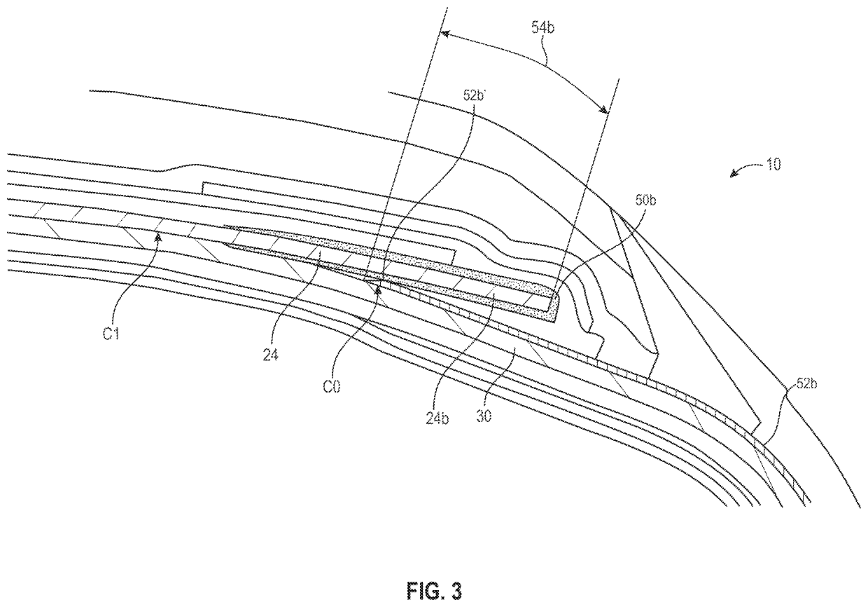

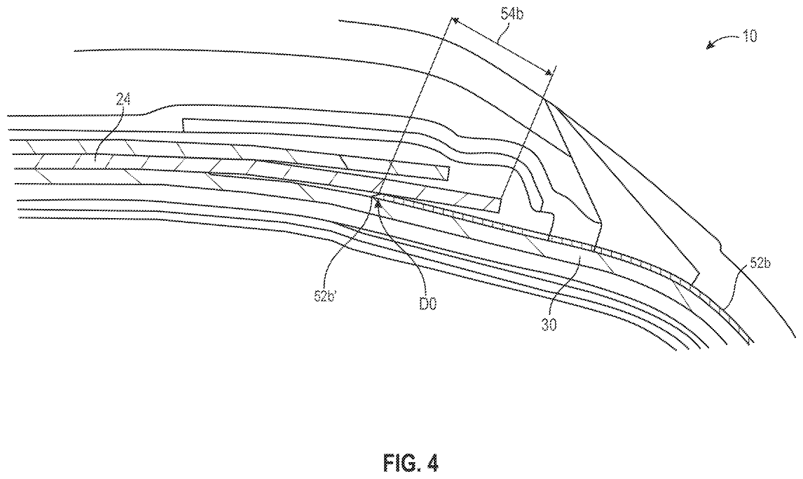

As illustrated, each wedge 40a,40b extends axially outward past a respective lateral edge 24a′, 24b′ of the first belt 24 to be between the respective lateral end portion 12a, 12b of the tread cap 12 and the first ply 30. In alternative embodiments to FIG. 1, a tire 10 may not include the pair of wedges 40a,40b (see, e.g., FIGS. 3 and 4). All other disclosure related to FIG. 1 would be applicable to this alternative embodiment.

The tire 10 further comprises a pair of wraparound gum layers 50a,50b and a pair of sidewall gum layers 52a,52b. Each of the wraparound gum layers 50a,50b wraps around a respective lateral end portion 24a,24b of the first belt 24 (the radially innermost belt). Each wraparound gum layer 50a,50b extends along an outer surface of the first belt 24 (the radially innermost belt), wraps around a respective end of the first belt 24, and extends along an inner surface of the first belt 24. That is, a first wraparound gum layer 50a wraps around a first lateral end portion 24a of the first belt 24 (the radially innermost belt), a second wraparound gum layer 50b wraps around a second lateral end portion 24b of the first belt 24 (the radially innermost belt).

Each wraparound gum layer 50a,50b may extend along the inner and outer surfaces of the first belt 24 (the radially innermost belt), cumulatively, for 10 mm to 30 mm (or 15 mm to 25 mm). The length that each wraparound gum layer 50a,50b extends along the inner and outer surfaces of the first belt 24 may be different or the same.

In alternate embodiments to FIG. 1, the tire 10 may further comprise one or more additional pairs of wraparound gum layers that each wrap around a lateral end portion of other belts in the belt structure 14. For example, the tire 10 may further comprise a second pair of wraparound gum layers where each wraparound gum layer wraps around a lateral end portion of second belt 26. If a third belt is included in the belt structure, a pair of wraparound gum layers is associated with the radially innermost belt, and, if additional pair(s) of wraparound gum layers are include in the tire, a pair of wraparound gum layers may be associated with one or both of the other two belts. The disclosure relating to the dimensions, composition, and location for the wraparound gum layer 50a,50b of FIG. 1 apply to any of the one or more additional pairs of wraparound gum layers relative to the belt to which said additional pair(s) of wraparound gum layers is associated. In other alternative embodiments to FIG. 1, a tire 10 may not include any wraparound gum layers 50a,50b (see, e.g., FIG. 4). All other disclosure related to FIG. 1 would be applicable to this alternative embodiment.

Each of the sidewall gum layers 52a,52b extends along an outer surface of the first ply 30 (the radially outermost ply) of the carcass 22 from a first end 52a′,52b′ to a second end 52a″,52b″. Inner surfaces of the sidewall gum layers 52a,52b are in contact with the first ply 30 along an entire length of the sidewall gum layers 52a,52b. The first end 52a′, 52b′ is located axially inward of the corresponding lateral edge 24a′ 24b′ of the first belt 24 and radially between the first ply 30 (the radially outermost ply) and the respective lateral end portion 24a,24b of the first belt 24 (the radially innermost belt). Each of the sidewall gum layers 52a,52b laterally overlaps the first belt 24 (the radially innermost belt) to define a laterally overlapping region 54a,54b. In some embodiments, the laterally overlapping regions 54a,54b extending for a length of at least 6 mm each. The second end 52a″, 52b″ is located at or within the respective bead region 20a,20b. That is, a first sidewall gum layer 52a extends along an outer surface of the first ply 30 (the radially outermost ply) from a first end 52a′ between the first ply 30 and the first lateral end portion 24a of the first belt 24 (the radially innermost belt) to a second end 52a″ at a first bead region 20a wrapped by at least the second ply 32, and a second sidewall gum layer 52b extends along an outer surface of the first ply 30 from a first end 52b′ between the first ply 30 and the second lateral end portion 24b of the first belt 24 to a second end 52b″ at a second bead region 20b wrapped by at least the second ply 32.

Portions of each sidewall gum layer 52a,52b are located between and contacting the first ply 30 and (a) the wedge 40a, 40b at or near the first end 52a′, 52b′, (b) the sidewall 16,18, (c) the turned up ends 32a,32b of the second ply 32 (the most radially inward ply), and (d) the bead filler apex 38a,38b at or near the second end 52a″, 52b″.

As illustrated in FIG. 1, the second end 52a″ of the sidewall gum layer 52a is disposed at a location designated by A0. The second end 52a″ is located between and in contact with both the first ply 30 and the bead filler apex 38a on an axially inward side of the bead filler apex 52a″. In other embodiments, the sidewall gum layer 52a may extend a greater or lesser distance within the bead region 20a. For example, the sidewall gum layer 52a may extend to location A1 such that the second end 52a″ is located between and in contact with the first ply 30 and the bead core 36a. Similarly, the sidewall gum layer 52a may extend to location A2 such that the second end 52a″ is located between and in contact with the first ply 30 and the turned up end 32a of the second ply 32. The sidewall gum layer 52b may be similarly arranged with respect to the corresponding bead region 20b.

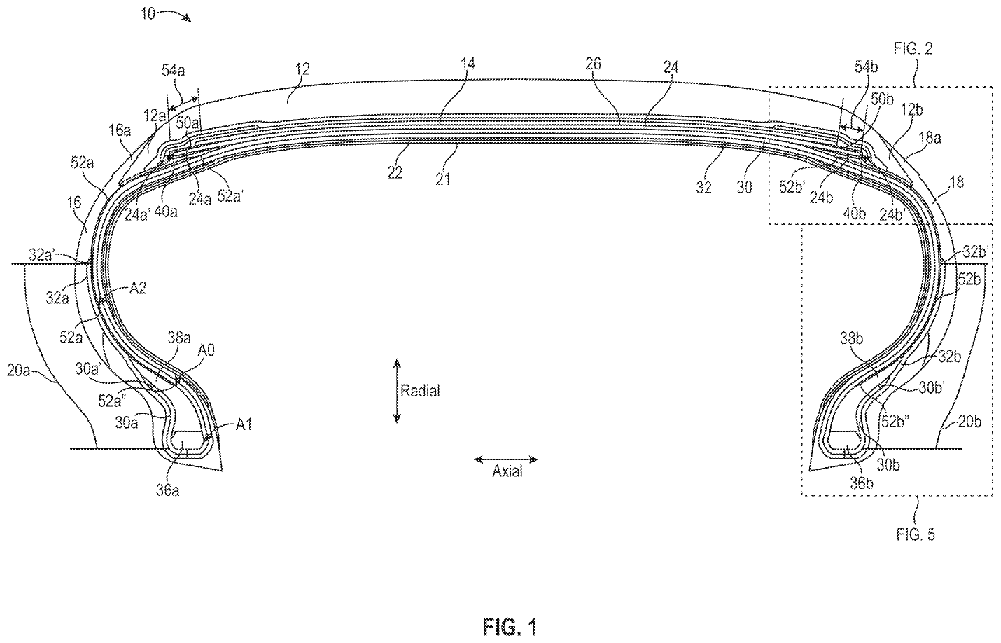

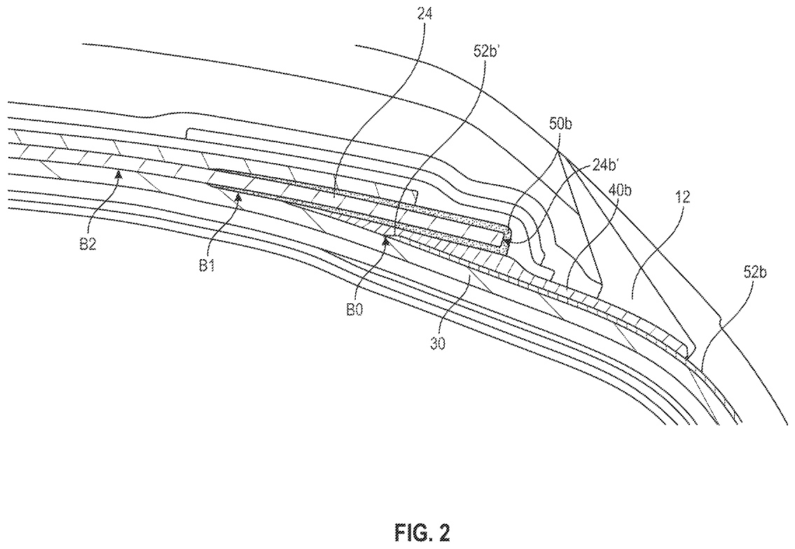

As illustrated in FIG. 2, the first end 52b′ of the sidewall gum layer 52b is disposed at a location B0, which is radially between and in contact with the first ply 30 and the wedge 40b. In alternative embodiments to FIG. 2, the sidewall gum layers 52b may extend further along the first ply 30 to locations more axially inward from the lateral edge 24b′ of the first belt 24. For example, the sidewall gum layer 52b may extend beyond the wedge 40b to a location B1, which is radially between and in contact with the first ply 30 and wraparound gum layer 50b. Similarly, the sidewall gum layer 52b may extend beyond the wraparound gum layer 50b to a location B2, which is radially between and in contact with the first ply 30 and the first belt 24. The sidewall gum layer 52a (FIG. 1) may be similarly arranged with respect to the first belt 24. In embodiments where the sidewall gum layers 52a,52b extend axially inward from the wedges 40a,40b, portions of each sidewall gum layer 52a,52b can be located between and contacting the first ply 30 and (a) the wraparound gum layers 50a,50b and/or the first belt 24 (the radially innermost belt), (b) the wedge 40a,40b at or near the first end 52a′, 52b′, (c) the sidewall 16,18, (d) the turned up ends 32a,32b of the second ply 32 (the most radially inward ply), (e) the bead filler apex 38a,38b at or near the second end 52a″, 52b″ and (f) the bead core 36a, 36b at or near the second end 52a″, 52b″.

In other alternative embodiments, e the tire 10 may not include the pair of wedges 40a,40b as illustrated in FIG. 3. In these embodiments, the first end 52b′ of the sidewall gum layer 52b is disposed at a location C0, which is radially between and in contact with the first ply 30 and the wraparound gum layer 50b. The sidewall gum layer 52b may support the lateral end portion 24b and assist in maintaining a predetermined curvature of the first belt 24 in a manner similar to the wedge 40b (FIG. 2) described above. A length of the laterally overlapping region 54b may be adjusted to adjust the curvature of the first belt 24. For example, the sidewall gum layer 50b may extend axially to a location C1, which is radially between and in contact with the first ply 30 and the first belt 24. Since the sidewall gum layer 52b may function as a wedge 40b to maintain a predetermined curvature of the first belt 24, the wedge 40b to be removed from some designs. Removing the wedge 40b may lower costs and simplify the manufacturing process. The sidewall gum layer 52a (FIG. 1) may be similarly arranged with respect to the first belt 24. In embodiments where no wedge 24 is provided, portions of each sidewall gum layer 52a,52b can be located between and contacting the first ply 30 and (a) the wraparound gum layers 50a,50b and/or the first belt 24 (the radially innermost belt), (b) the sidewall 16,18, (c) the turned up ends 32a,32b of the second ply 32 (the most radially inward ply), (d) the bead filler apex 38a,38b at or near the second end 52a″, 52b″, and (c) the bead core 36a,36b at or near the second end 52a″, 52b″.

Referring to FIG. 4, in other alternative embodiments, the tire 10 may not include the wraparound gum layers 50a, 50b (FIG. 2). In these embodiments, the first end 52b′ of the sidewall gum layer 52b is disposed at a location DO, which is radially between and in contact with the first ply 30 and the first belt 24. Laterally overlapping region 54b is defined between the first end 52b′ of the sidewall gum layer 52b and the lateral edge 24b′ of the first belt 24. The sidewall gum layer 52a (FIG. 1) may be similarly arranged with respect to the first belt 24.

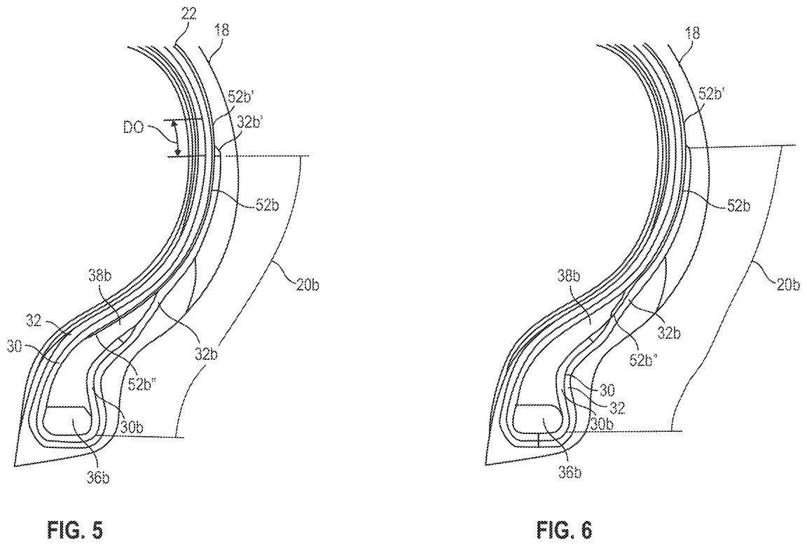

Referring to FIG. 5, the sidewall gum layer 52b and bead region 20b of FIG. 1 are illustrated in greater detail. The bead region 20b is wrapped by the carcass 22 and includes bead core 36b therein. As illustrated in FIG. 5, the bead region 20b also includes the optional bead filler apex 38b and a portion of the sidewall gum layer 52b that is wrapped by the carcass 22. The bead region 20b is bounded laterally by the first and second plies 30, 32 on a laterally inner side thereof and by the turned up ends 30b, 32b on a laterally outer side thereof. The bead region 20b is bounded radially by a radially innermost edge of the annular bead core 36b and a radially outermost end point 32b′ of the turned up ends 30b, 32b.

The sidewall gum layer 52b extends along the ply 30 from the first belt 24 (FIG. 2) across the end point 32b′ and into the bead region 20b. Radially outwardly of the end point 32b′, the sidewall gum layer 52b is laterally interposed between the carcass 22 and the sidewall 18 such that a laterally inner side of the sidewall gum layer 52b is contacted by the first ply 30 and a laterally outer side of the sidewall gum layer 52b is contacted by the sidewall 18. The second end 52b″ of the sidewall gum layer 52b is disposed within the bead region 20b. A laterally inner side of the second end 52b″ is contacted by the first ply 30 and a laterally outer side of the second end 52b″ is contacted by the bead filler apex 38b.

Referring to FIGS. 6 through 8, in alternate embodiments, different configurations of the bead region 20b and the sidewall gum layer 52b are contemplated. As illustrated in FIG. 6, the sidewall gum layer 52b extends along a laterally outer side of the bead filler apex 38b such that the second end 52b″ is contacted by the bead filler apex 38b and the turned up end 32b of the second ply 32. As illustrated in FIG. 7, the bead region 20b does not include a bead filler apex, and the carcass 22 wraps the bead core 36b and a portion of the sidewall gum layer 52b. The sidewall gum layer 52b extends to the bead core 36b such that the second end 52b″ is contacted by the bead core 36b and the turned up end 30b. As illustrated in FIG. 8, the sidewall gum layer 52b extends to a point within the bead region 20b that is radially outward of the bead filler apex 38b. The second end 52b″ is contacted by the first ply 30 on a laterally inner side thereof and by the turned up end 32b on a laterally outer side thereof. The second end 52b″ is disposed radially outward of a radially innermost portion 18b of the sidewall 18. In any of the configurations illustrated in FIGS. 6 through 8, the sidewall gum layer 52 will absorb and dissipate energy and heat generated when the sidewall 18 flexes as described above.

The length of each sidewall gum layer 52a,52b may be 50 mm to 90 mm (or 55 mm to 75 mm).

The gum layers (e.g., the wraparound gum layers 50a,50b and the sidewall gum layers 52a,52b) used in the construction of the tires described herein can be formed of a rubber and/or elastomer. Preferably, the rubber and/or the elastomer of the gum layer has a Shore A hardness between 80 and 95, tested according to ASTM S2240-15(2021) with a cure of 18 minutes at 150° C. Further, the rubber and/or the elastomer of the gum layer has a RPA G′ 1 percent of 4 MPa or greater. As used herein, the term “RPA” means rubber processing analyzer analytical equipment as produced by the Monsanto Company, and referred to as “RPA 2000.” The term “RPA G′ 1 percent” refers to the dynamic storage modulus “G′” at a one (1) percent strain (elongation) as determined by the RPA 2000 analytical equipment measured at 100° C.

The gum layers may have a thickness of 0.2 mm to 2 mm (or 0.2 mm to 1 mm, or 0.5 mm to 1.5 mm, or 1 mm to 2 mm). Each gum layer may have the same or a different thickness from each other.

The rubber that at least partially forms parts of the tire like the innerliner, carcasses (including the carcass plies), belt structures, and tread portions may comprise a rubber. Specific examples of suitable rubbers may include, but are not limited to, neoprene (polychloroprene), polybutadiene (including cis-1,4-polybutadiene), polyisoprene (including cis-1,4-polyisoprenc) (natural or synthetic), butyl rubber, halobutyl rubber (including chlorobutyl rubber or bromobutyl rubber), styrene/isoprene/butadiene rubber, copolymers of 1,3-butadiene or isoprene with monomers such as styrene, acrylonitrile and methyl methacrylate, ethylene/propylene terpolymers (also known as ethylene/propylene/diene monomer (EPDM) terpolymers (e.g., ethylene/propylene/dicyclopentadiene terpolymers)), alkoxy-silyl end functionalized solution polymerized polymers, styrene-butadiene rubber, polybutadiene rubber, isoprene butadiene rubber, styrene isoprene butadiene rubber, the like, and any combination thereof. The foregoing rubbers may also include conventional rubber compounding ingredients including, but not limited to, processing oil, accelerators, conventional sulfur curing agents, pigments, carbon black, zinc oxide, stearic acid, tackifying resin, plasticizer, the like, and any combination thereof.

The production of the tires of the present disclosure may include assembling the tire components followed by curing according to production methods conventionally known in the art, which may be dependent on the type of tire. For example, U.S. Pat. No. 10,960,627, which is incorporated herein by reference, describes methods for producing tires. Generally, gum layers typically come in a roll (e.g., 1 cm to 20 cm wide). One skilled in the art, with the benefit of this disclosure, will recognize how to apply the gum layers to achieve the various embodiments of tires described herein.

### EXAMPLE EMBODIMENTS

Embodiment 1 A pneumatic tire comprising: first and second annular bead cores axially spaced from one another; a carcass including at least one ply wrapped around the first and second bead cores, each ply of the at least one ply defining a pair of turned up ends extending from the bead cores to outer end points of each ply; first and second bead regions wrapped by the at least one ply such that the first and second bead regions are bounded laterally by the at least one ply and the turned up ends, and bounded radially by radially innermost edges of respective annular bead cores and radially outermost end points of respective turned up ends; a belt structure disposed radially outward of the carcass, the belt structure including a radially innermost belt having first and second lateral end portions terminating in respective first and second lateral edges of the radially innermost belt respectively; and first and second sidewall gum layers each extending along a surface of the at least one ply from a first end to a second end, the first end disposed axially inward of a respective lateral edge of the radially innermost belt and radially between the at least one ply and a respective lateral end portion of the radially innermost belt, the second end disposed within a respective bead region of the first and second bead regions.

Embodiment 2 The tire of Embodiment 1 wherein each of the sidewall gum layers is constructed a rubber and/or an elastomer having a Shore A hardness between 80 and 95.

Embodiment 3. The tire of Embodiment 1 or 2, wherein each of the sidewall gum layers is constructed a rubber and/or an elastomer having a RPA G′ 1 percent of 4 MPa or greater.

Embodiment 4. The tire of any of Embodiments 1-3, wherein each of the sidewall gum layers has a length within a range from 50 mm to 90 mm.

Embodiment 5. The tire of any of Embodiments 1-4, wherein each of the sidewall gum layers has a thickness within a range from 0.2 mm to 2 mm.

Embodiment 6. The tire of any of Embodiments 1-5, further comprising a pair of wedges, wherein a first wedge of the pair of wedges is disposed, at least partially, axially inward of the lateral edge of the first lateral end portion of the radially innermost belt and radially between the first lateral end portion and the at least one ply, and wherein a second wedge of the pair of wedges is disposed, at least partially, axially inward of the lateral edge of the second lateral end portion of the radially innermost belt and radially between the second lateral end portion and the at least one ply.

Embodiment 7. The tire of Embodiment 6, wherein the first end of each of the sidewall gum layers is disposed radially between, and in contact with, the at least one ply and a corresponding wedge of the pair of wedges.

Embodiment 8. The tire of any of Embodiments 1-7, further comprising first and second wraparound gum layers, wherein the first wraparound gum layer wraps around the first lateral end portion of the radially innermost belt, wherein the second wraparound gum layer wraps around the second lateral end portion of the radially innermost belt, and wherein the first end of each of the sidewall gum layers is disposed radially between and contacting the at least one ply and a corresponding one of first and second of wraparound gum layers.

Embodiment 9. The tire of any of Embodiments 1-8, wherein the first end of each of the sidewall gum layers is radially between and contacting the at least one ply and the corresponding first or second lateral end portion of the radially innermost belt.

Embodiment 10. The tire of any of Embodiments 1-9, wherein each of the wraparound gum layers extends along an inner surface and an outer surface of the radially innermost belt for a cumulative distance in a range of 10 mm to 30 mm.

Embodiment 11. The tire of any of Embodiments 1-10, wherein the pair of wraparound gum layers is a first pair of wraparound gum layers, wherein the belt structure further comprises a second belt, and wherein the tire further comprises a second pair of wraparound gum layers that wrap around lateral end portions of the second belt.

Embodiment 12. The tire of any of Embodiments 1-11, wherein the first bead region further comprises a first bead filler apex disposed radially outward of the first annular bead core, wherein the second bead region further comprises a second bead filler apex disposed radially outward of the second annular bead core, and wherein the second end of each of the sidewall gum layers contacts a corresponding one of the first and second bead filler apexes.

Embodiment 13. A pneumatic tire comprising: a tread cap; a carcass that comprises at least one ply wrapped around first and second axially spaced bead cores, each ply of the at least one ply defining a pair of turned up ends extending from the bead cores to outer end points of each ply; a belt structure interposed between the carcass and the tread cap, the belt structure comprising a radially innermost belt terminating at opposed first and second lateral edges; a pair of sidewall portions, wherein radially outermost portions of each sidewall overlie lateral end portions of the tread cap; a pair of bead regions each including an annular bead core of the first and second bead cores, wherein the carcass wraps around the pair of bead regions such that the regions are bounded laterally by the at least one ply and the turned up ends, and bounded radially by radially innermost edges of the respective annular bead cores and radially outermost end points of respective turned up ends; and a pair of sidewall gum layers, wherein a first sidewall gum layer extends along a surface of the at least one ply from a first end axially inward of the first lateral edge of the radially innermost belt to a second end within a first bead region of the pair of bead regions, and wherein a second sidewall gum layer extends along the surface of the at least one ply from a first end axially inward of the second lateral edge of the first belt to a second end within a second bead region of the pair of bead regions.

Embodiment 14. The tire of Embodiment 13, further comprising a pair of wedges, wherein an inner end of each wedge is disposed radially between the first belt and the at least one ply and wherein an outer end of each wedge is disposed radially between and in contact with one of the lateral end portions of the tread cap and the at least one ply.

Embodiment 15. The tire of Embodiment 14, further comprising a pair wraparound gum layers, wherein a first wraparound gum layer wraps around a first lateral end portion of the first belt, and wherein a second wraparound gum layer wraps around a second lateral end portion of the first belt, and wherein the inner ends of each wedge are in contact with a corresponding wraparound gum layer.

Embodiment 16. The tire of Embodiment 15, wherein the first end of each of the sidewall gum layers is in contact with the at least one ply and a corresponding wedge.

Embodiment 17. The tire of any of Embodiments 13-16, wherein each of the bead regions includes an bead filler apex therein disposed radially outward of the annular bead core therein, and wherein the second end of each sidewall gum layer is in contact with a corresponding bead filler apex.

Embodiment 18. The tire of any of Embodiments 13-17, wherein each of the sidewall gum layers has a length in a range of 50 mm to 90 mm.

Embodiment 19. The tire of any of Embodiments 13-18, wherein each of the sidewall gum layers comprise a rubber and/or an elastomer having a Shore A hardness between 80 and 95 and a RPA G′ 1 percent of 4 MPa or greater.

Embodiment 20. A pneumatic tire comprising: a carcass that comprises at least one ply wrapped around first and second axially spaced bead cores, each ply of the at least one ply defining a pair of turned up ends extending from the bead cores to outer end points of each ply; a belt structure disposed radially outward of the carcass, the belt structure comprising a radially innermost belt having two lateral end portions; a pair of bead regions, wherein the at least one ply wraps around the pair of bead regions such that the regions are bounded laterally by the at least one ply and the turned up ends, and bounded radially by radially innermost edges of the respective annular bead cores and radially outermost end points of respective turned up ends; a pair of sidewall portions, wherein each of the sidewall portions is disposed axially outward of one of the pair of bead regions; and a pair of sidewall gum layers, wherein a first sidewall gum layer is disposed axially between a first sidewall portion of the pair of sidewall portions and extends along a surface of the at least one ply from a first end between the at least one ply and the first lateral end portion of the radially innermost belt to a second end within a first bead region of the pair of bead regions, and wherein a second sidewall gum layer is disposed axially between a second sidewall portion of the pair of sidewall portions and extends along the surface of the at least one ply from a first end between the at least one ply and the second lateral end portion of the radially innermost belt to a second end within a second bead region of the pair of bead regions

To facilitate a better understanding of the embodiments of the present invention, the following examples of preferred or representative embodiments are given. In no way should the following examples be read to limit, or to define, the scope of the invention.

### EXAMPLES

Gum layers of 0.5 mm to 0.6 mm thickness were used in the construction of seven different vehicle tire configurations, each similar to FIG. 1. Under high-load testing, the durability of the tire was improved with only a minor increase (about 1% to 2%) in rolling resistance as compared to said configurations without the sidewall gum layers.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present invention are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising:
first and second annular bead cores axially spaced from one another;
a carcass including at least one ply wrapped around the first and second bead cores, each ply of the at least one ply defining a pair of turned up ends extending from the bead cores to outer end points of each ply;
first and second bead regions wrapped by the at least one ply such that the first and second bead regions are bounded laterally by the at least one ply and the turned up ends, and bounded radially by radially innermost edges of respective annular bead cores and radially outermost end points of respective turned up ends;
a belt structure disposed radially outward of the carcass, the belt structure including a radially innermost belt having first and second lateral end portions terminating in respective first and second lateral edges of the radially innermost belt respectively; and
first and second sidewall gum layers each extending along a surface of the at least one ply from a first end to a second end, the first end disposed axially inward of a respective lateral edge of the radially innermost belt and radially between the at least one ply and a respective lateral end portion of the radially innermost belt, the second end disposed within a respective bead region of the first and second bead regions.

2. The tire of claim 1, wherein each of the sidewall gum layers is constructed a rubber and/or an elastomer having a Shore A hardness between 80 and 95.

3. The tire of claim 1, wherein each of the sidewall gum layers is constructed a rubber and/or an elastomer having a RPA G′ 1 percent of 4 MPa or greater.

4. The tire of claim 1, wherein each of the sidewall gum layers has a length within a range from 50 mm to 90 mm.

5. The tire of claim 1, wherein each of the sidewall gum layers has a thickness within a range from 0.2 mm to 2 mm.

6. The tire of claim 1, further comprising a pair of wedges, wherein a first wedge of the pair of wedges is disposed, at least partially, axially inward of the lateral edge of the first lateral end portion of the radially innermost belt and radially between the first lateral end portion and the at least one ply, and wherein a second wedge of the pair of wedges is disposed, at least partially, axially inward of the lateral edge of the second lateral end portion of the radially innermost belt and radially between the second lateral end portion and the at least one ply.

7. The tire of claim 6, wherein the first end of each of the sidewall gum layers is disposed radially between, and in contact with, the at least one ply and a corresponding wedge of the pair of wedges.

8. The tire of claim 1, further comprising first and second wraparound gum layers, wherein the first wraparound gum layer wraps around the first lateral end portion of the radially innermost belt, wherein the second wraparound gum layer wraps around the second lateral end portion of the radially innermost belt, and wherein the first end of each of the sidewall gum layers is disposed radially between and contacting the at least one ply and a corresponding one of first and second of wraparound gum layers.

9. The tire of claim 1, wherein the first end of each of the sidewall gum layers is radially between and contacting the at least one ply and the corresponding first or second lateral end portion of the radially innermost belt.

10. The tire of claim 1, wherein each of the wraparound gum layers extends along an inner surface and an outer surface of the radially innermost belt for a cumulative distance in a range of 10 mm to 30 mm.

11. The tire of claim 1, wherein the pair of wraparound gum layers is a first pair of wraparound gum layers, wherein the belt structure further comprises a second belt, and wherein the tire further comprises a second pair of wraparound gum layers that wrap around lateral end portions of the second belt.

12. The tire of claim 1, wherein the first bead region further comprises a first bead filler apex disposed radially outward of the first annular bead core, wherein the second bead region further comprises a second bead filler apex disposed radially outward of the second annular bead core, and wherein the second end of each of the sidewall gum layers contacts a corresponding one of the first and second bead filler apexes.

13. A pneumatic tire comprising:
a tread cap;
a carcass that comprises at least one ply wrapped around first and second axially spaced bead cores, each ply of the at least one ply defining a pair of turned up ends extending from the bead cores to outer end points of each ply;
a belt structure interposed between the carcass and the tread cap, the belt structure comprising a radially innermost belt terminating at opposed first and second lateral edges;
a pair of sidewall portions, wherein radially outermost portions of each sidewall overlie lateral end portions of the tread cap;
a pair of bead regions each including an annular bead core of the first and second bead cores, wherein the carcass wraps around the pair of bead regions such that the regions are bounded laterally by the at least one ply and the turned up ends, and bounded radially by radially innermost edges of the respective annular bead cores and radially outermost end points of respective turned up ends; and
a pair of sidewall gum layers, wherein a first sidewall gum layer extends along a surface of the at least one ply from a first end axially inward of the first lateral edge of the radially innermost belt to a second end within a first bead region of the pair of bead regions, and wherein a second sidewall gum layer extends along the surface of the at least one ply from a first end axially inward of the second lateral edge of the first belt to a second end within a second bead region of the pair of bead regions.

14. The tire of claim 13, further comprising a pair of wedges, wherein an inner end of each wedge is disposed radially between the first belt and the at least one ply and wherein an outer end of each wedge is disposed radially between and in contact with one of the lateral end portions of the tread cap and the at least one ply.

15. The tire of claim 14, further comprising a pair wraparound gum layers, wherein a first wraparound gum layer wraps around a first lateral end portion of the first belt, and wherein a second wraparound gum layer wraps around a second lateral end portion of the first belt, and wherein the inner ends of each wedge are in contact with a corresponding wraparound gum layer.

16. The tire of claim 15, wherein the first end of each of the sidewall gum layers is in contact with the at least one ply and a corresponding wedge.

17. The tire of claim 13, wherein each of the bead regions includes an bead filler apex therein disposed radially outward of the annular bead core therein, and wherein the second end of each sidewall gum layer is in contact with a corresponding bead filler apex.

18. The tire of claim 13, wherein each of the sidewall gum layers has a length in a range of 50 mm to 90 mm.

19. The tire of claim 13, wherein each of the sidewall gum layers comprise a rubber and/or an elastomer having a Shore A hardness between 80 and 95 and a RPA G′ 1 percent of 4 MPa or greater.

20. A pneumatic tire comprising:
a carcass that comprises at least one ply wrapped around first and second axially spaced bead cores, each ply of the at least one ply defining a pair of turned up ends extending from the bead cores to outer end points of each ply;
a belt structure disposed radially outward of the carcass, the belt structure comprising a radially innermost belt having two lateral end portions;
a pair of bead regions, wherein the at least one ply wraps around the pair of bead regions such that the regions are bounded laterally by the at least one ply and the turned up ends, and bounded radially by radially innermost edges of the respective annular bead cores and radially outermost end points of respective turned up ends;
a pair of sidewall portions, wherein each of the sidewall portions is disposed axially outward of one of the pair of bead regions; and
a pair of sidewall gum layers, wherein a first sidewall gum layer is disposed axially between a first sidewall portion of the pair of sidewall portions and extends along a surface of the at least one ply from a first end between the at least one ply and the first lateral end portion of the radially innermost belt to a second end within a first bead region of the pair of bead regions, and wherein a second sidewall gum layer is disposed axially between a second sidewall portion of the pair of sidewall portions and extends along the surface of the at least one ply from a first end between the at least one ply and the second lateral end portion of the radially innermost belt to a second end within a second bead region of the pair of bead regions.

21. A pneumatic tire comprising:
first and second annular bead cores axially spaced from one another;
first and second bead apexes extending radially outward of the first and second annular bead cores;
at least one ply,
a belt having first and second lateral edges; and
first and second sidewall gum layers each having a first end and a second end, wherein the second end is located radially inward of the respective first and second bead apex.

22. The tire of claim 21 wherein the first end is disposed axially inward of a respective lateral edge of the belt.

23. The tire of claim 21 wherein the first end is located between a shoulder of the tire and a midportion of the sidewall.

24. The tire of claim 21 wherein the first end is located radially outward of a midportion of the sidewall.

25. The tire of claim 21 wherein the first end is located axially outward of the lateral belt edge.

26. The tire of claim 21, wherein each of the sidewall gum layers is constructed a rubber and/or an elastomer having a Shore A hardness between 80 and 95.

27. The tire of claim 21, wherein each of the sidewall gum layers is constructed a rubber and/or an elastomer having a RPA G′ 1 percent of 4 MPa or greater.

28. The tire of claim 21, wherein each of the sidewall gum layers has a length within a range from 50 mm to 90 mm.

29. The tire of claim 21, wherein each of the sidewall gum layers has a thickness within a range from 0.2 mm to 2 mm.

30. The tire of claim 21 further comprising a wedge positioned between a belt lateral edge and the sidewall gum layer.

31. The tire of claim 30 wherein the thickness of each wedge is in the range of 0.5 to 1.5 mm.

32. The tire of claim 30 wherein each wedge comprises a rubber and/or an elastomer having a Shore A hardness between 80 and 95 and a RPA G′ 1 percent of 4 MPa or greater.

33. The tire of claim 21 further comprising a wrap around gum strip secured to the lateral belt edge.

34. The tire of claim 33 wherein the wrap around gum strip comprises a rubber and/or an elastomer having a Shore A hardness between 80 and 95 and a RPA G′ 1 percent of 4 MPa or greater.

35. The tire of claim 33 wherein the thickness of the wrap around gum strip is in the range of 0.2 mm to 0.7 mm.
